(19) United States
(12) Patent Application Publication
(10) Pub. No.: US 2021/0239157 A1
(43) Pub. Date: Aug. 5, 2021

(54) TENSIONER HAVING A ROLLER ASSEMBLY WITH A BEARING AND A ROLLER HAVING FEATURES FOR AXIALLY SECURING AN OUTER BEARING RACE OF THE BEARING TO THE ROLLER

(71) Applicant: BorgWarner Inc., Auburn Hills, MI (US)

(72) Inventor: Shawn J. BLACKMUR, Brooktondale, NY (US)

(21) Appl. No.: 16/782,389

(22) Filed: Feb. 5, 2020

(51) Int. Cl. F16C 19/16; F16H 7/12

(52) U.S. Cl. CPC F16C 19/16; F16H 2007/081; F16C 2361/00; F16H 7/1281

(57) ABSTRACT

A tensioner with a pivoting arm and a roller assembly having a bearing and a roller. The bearing supports the roller relative to the arm for rotation about a roller axis that is parallel to but offset from the pivot axis. The roller has a bearing socket and one or more locking tabs. The bearing socket has an annular bearing surface and a stop that is disposed radially inwardly from the annular bearing surface. Each of the locking tabs is resiliently coupled to an adjacent portion of the roller. The bearing is received in the bearing socket such that the outer bearing race of the bearing is disposed axially between the stop and the distal ends of each of the locking tabs. The locking tabs limit axial movement of the outer bearing race along the roller axis in a direction away from the stop.

### FIELD

The present disclosure relates to tensioner having a roller assembly with a bearing and a roller having features for axially securing an outer bearing race of the bearing to the roller.

### BACKGROUND

This section provides background information related to the present disclosure which is not necessarily prior art.

Tensioners of the type that are employed to tension belts commonly have a pivoting arm to which a roller assembly is rotatably mounted. The roller assembly is employed to engage the belt and commonly includes a roller and a bearing that supports the roller for rotation. The roller and the outer bearing race of the bearing can be coupled in various different manners. For example, the outer bearing race can be press-fit into the roller. As another example, the roller can be formed of a plastic material and can be overmolded onto the outer bearing race. In instances where the roller is formed out of a sheet metal, as when the roller is manufactured in a drawing operation, other more costly means of retention, such as snap rings or adhesives have been used. In the case of adhesives, care must also be taken to ensure that the adhesive is fully cured before axially directed loads can be applied to the roller assembly. Moreover, the aforementioned means of retaining the bearing to the roller are relatively sensitive to axially directed loads that can be applied to the roller assembly by the belt in some instances. In such cases, it is possible for the bearing to separate and move axially relative to the roller.

In view of the above drawbacks, there is a need in the art for a tensioner with an improved roller assembly that is easy to manufacture and assemble and is resistant to axially directed forces.

### SUMMARY

This section provides a general summary of the disclosure, and is not a comprehensive disclosure of its full scope or all of its features.

In one form, the present disclosure provides a tensioner for tensioning a belt. The tensioner includes a base, an arm, which is coupled to the base for movement relative to a movement axis, and a roller assembly having a bearing and a roller. The bearing supports the roller relative to the arm for rotation about a roller axis that is spaced apart from the movement axis. The bearing has an outer bearing race, an inner bearing race, and a plurality of bearing elements that are disposed radially between the outer and inner bearing races. The roller has a wall member that defines a roller member, a bearing socket and one or more locking tabs. The roller member has an annular roller surface that is disposed concentrically about the roller axis and is configured to engage the belt. The bearing socket has an annular bearing surface, which is disposed concentrically within the annular roller surface, and a stop that is disposed radially inwardly from the annular bearing surface. Each of the locking tabs has a proximal end, which is resiliently coupled to an adjacent portion of the wall member, and a distal end that projects radially inward from the proximal end and the annular bearing surface. The bearing is received in the bearing socket such that the outer bearing race is disposed axially between the stop and the distal ends of each of the locking tabs. The one or more locking tabs limit axial movement of the outer bearing race along the roller axis in a direction away from the stop.

In another form, the present teachings provide a method for assembling a tensioner. The method includes: providing a bearing with an outer bearing race; inserting the bearing into a bearing socket in a roller along a roller axis such that distal ends of a plurality of locking tabs formed on the roller are urged in a radially outward direction by an outer circumferential surface of the outer bearing race; seating the bearing in the bearing socket such that the distal ends of the locking tabs release the outer circumferential surface of the outer bearing race and move radially inwardly to limit movement of the outer bearing race axially along the roller axis in a direction toward the distal ends of the locking tabs; securing the bearing to an arm member such that an annular roller surface of the roller is rotatable about the roller axis relative to the arm member; and coupling the arm member to a base for pivoting motion about a pivot axis.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary tensioner having a roller assembly constructed in accordance with the teachings of the present disclosure;

FIG. 2 is a section view taken along the line 2-2 of FIG. 1;

FIG. 3 is a front elevation view of a portion of the tensioner of FIG. 1 illustrating the roller assembly in more detail;

FIG. 4 is a perspective view of the roller assembly;

FIG. 5 is a perspective view of a portion of the roller assembly illustrating a roller in more detail;

FIG. 6 is a section view of the roller assembly taken along the line 6-6 of FIG. 3;

FIG. 7 is an enlarged portion of FIG. 5, illustrating a locking tab in more detail; and

FIG. 8 is an enlarged portion of FIG. 6.

Corresponding reference numerals indicate corresponding parts throughout the several views of the drawings.

### DETAILED DESCRIPTION

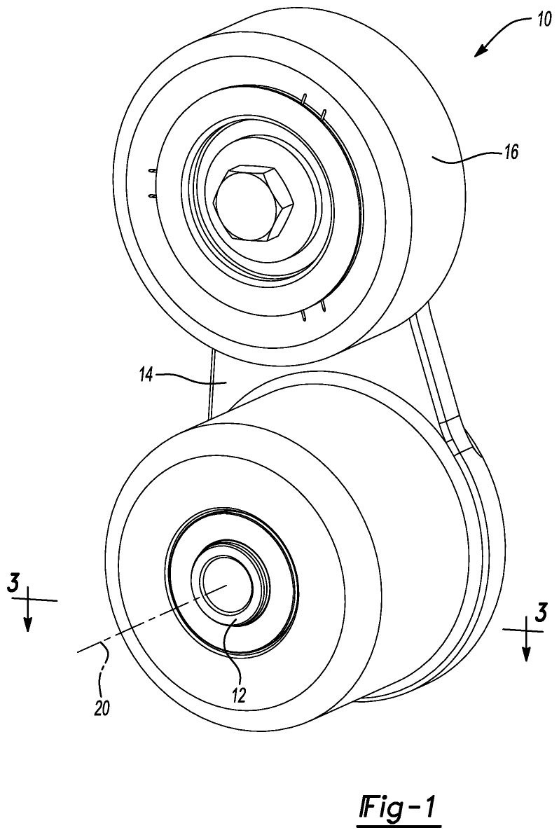

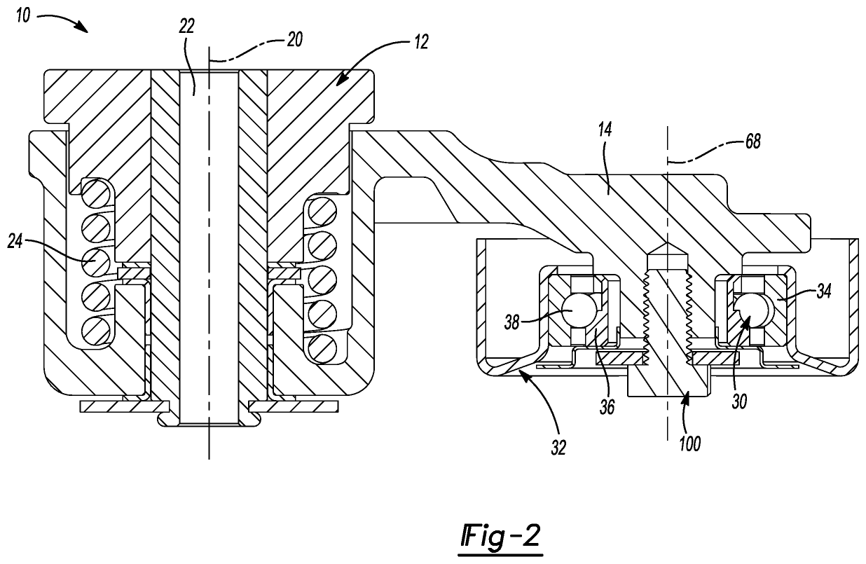

With reference to FIGS. 1 and 2, a tensioner constructed in accordance with the teachings of the present disclosure is generally indicated by reference numeral 10. The tensioner 10 can include a base 12, an arm 14 and a roller assembly 16. The base 12 is configured to be fixedly coupled to a suitable structure, such as the block of an internal combustion engine (not shown). The base 12 includes a pivot pin 18 that defines a pivot axis 20. The pivot pin 18 defines a pin aperture 22 that is configured to receive a fastener (not shown) therethrough to permit the base 12 to be fixedly but removably coupled to the suitable structure. The arm 14 can be coupled to the base 12 for pivoting motion about a pivot axis 20. A suitable biasing mechanism, such as a torsion spring 24, can be employed to exert a force or torque onto the arm 14 to bias the arm 14 about the pivot axis 20 in a predetermined direction. In the particular example shown, the torsion spring 24 is disposed in a load path between (and directly engages) the base 12 and the arm 14, but it will be appreciated that the torsion spring 24 could have been disposed between the arm 14 and another structure, such as a second arm (not shown) that is pivotably mounted on the pivot pin 18.

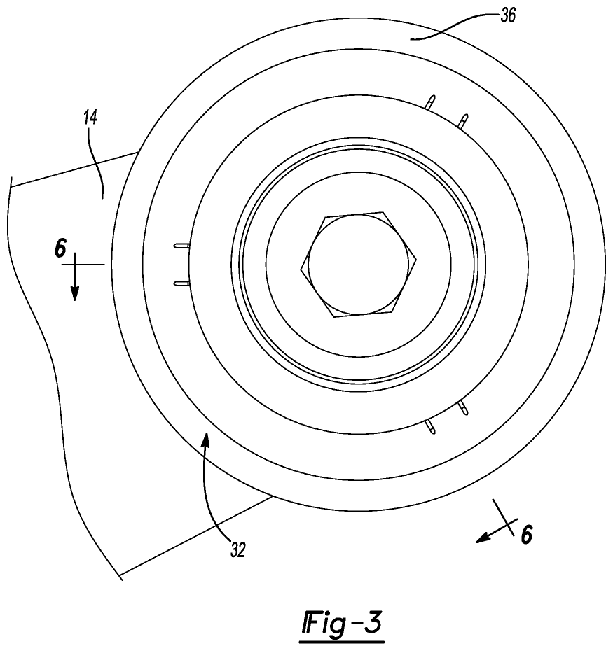

With reference to FIGS. 2 through 4, the roller assembly 16 can include a bearing 30 and a roller 32. The bearing 30 can be a conventional type of bearing, such as a rolling element bearing having an outer bearing race 34, an inner bearing race 36 and a plurality of bearing elements 38 that are disposed between the outer and inner bearing races 34 and 36. The bearing elements 38 can be sized and shaped in a desired manner, but are shown as spherical balls in the example provided. Optionally, the bearing 30 can be configured to provide axial as well as radial support and may take the form of an angular contact bearing.

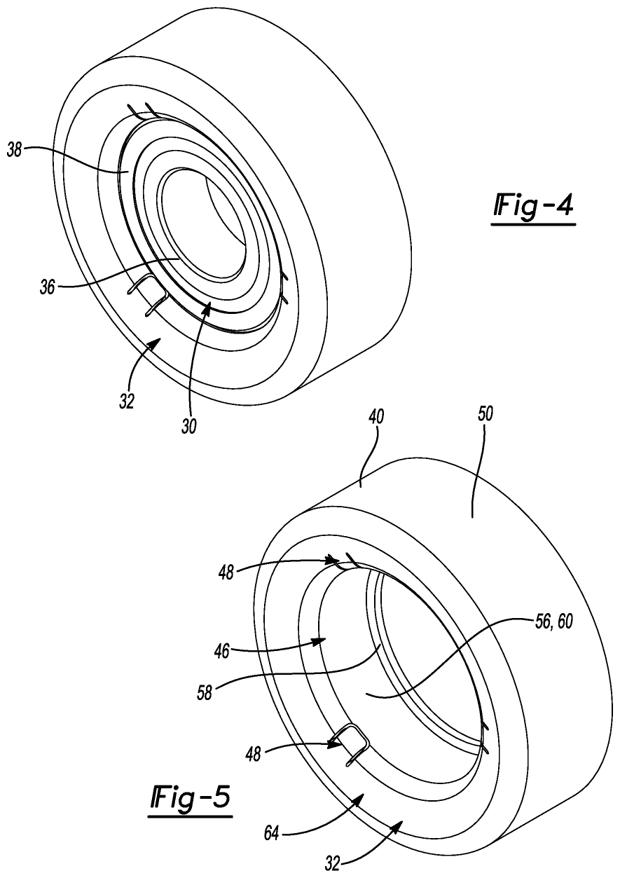

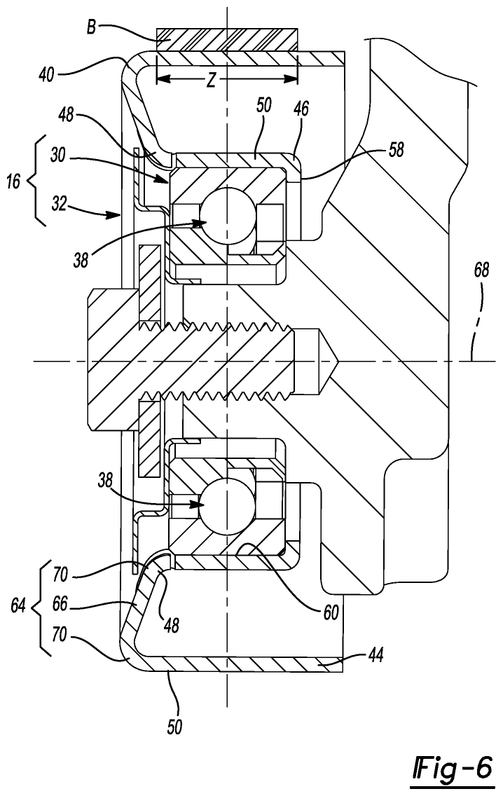

In FIGS. 5 and 6, the roller 32 can have a wall member 40 that defines a roller member 44, a bearing socket 46 and one or more locking tabs 48. The roller 32 can be unitarily and integrally formed in a casting, rolling, pressing (e.g., stamping, drawing) or molding operation and can be formed from any desired metal or plastic material. The roller member 44 can have an annular roller surface 50 that can be disposed concentrically about the roller axis—and which is configured to engage the belt. In the example shown, the annular roller surface 50 is a flat cylindrical surface, but it will be appreciated that the annular roller surface 50 could be shaped differently. For example, the annular roller surface 50 could define a plurality of V-shaped peaks (not shown) that are spaced apart from one another across the annular roller surface 50. Alternatively, the annular roller surface 50 could be configured in a sprocket-like manner to engage a chain or could have teeth that can be configured to engage a toothed belt.

The bearing socket 46 can have an annular wall 56 and a stop 58. The annular wall 56 can have an annular bearing surface 60 that can be disposed concentrically within the annular roller surface 50. The stop 58 can be disposed radially inwardly from the annular bearing surface 60. In the example shown, the stop 58 is formed by a segment of the wall member 40 that extends radially inward from the annular bearing surface 60.

The bearing socket 46 can be fixedly coupled to the roller member 44 in any desired manner. In the example shown, a transition section 64 of the wall member 40 fixedly couples the bearing socket 46 to the roller member 44. A portion 66 of the transition section 64 is frustoconical in shape and diverges outwardly from a roller axis 68 with increasing radial distance from the annular wall 56. In the example provided, the transition section 64 includes fillet radii 70 at the radially outer and inner ends of the frustoconical portion 66 that couple the frustoconical portion 66 to the roller member 44 and the bearing socket 46 respectively. Configuration of the roller 32 in this manner permits the roller 32 to be fabricated in a deep drawing operation.

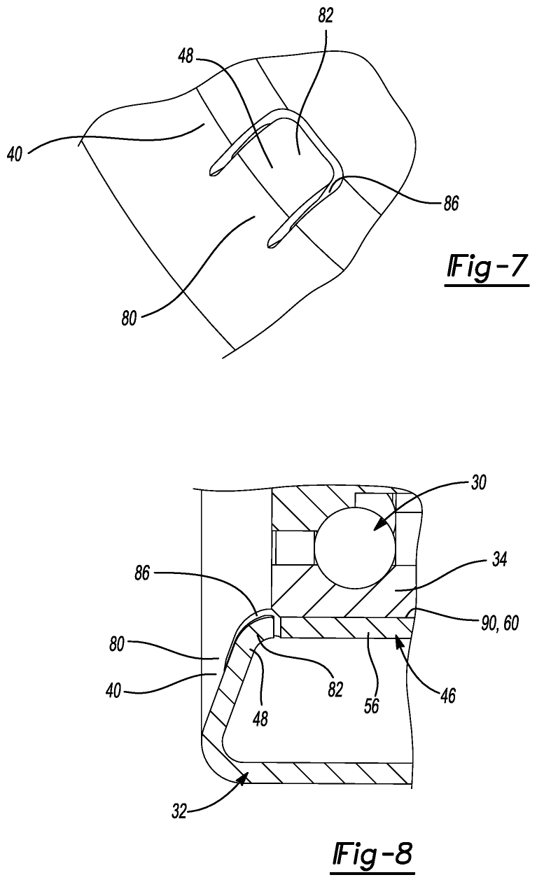

With reference to FIGS. 7 and 8, each of the locking tabs 48 can have a proximal end 80, which is resiliently coupled to an adjacent portion of the wall member 40, and a distal end 82 that projects radially inward from the proximal end 80 and the annular bearing surface 60. In the example shown, a slotted aperture 86 is formed in the wall member 40 about a perimeter of each of the locking tabs 48. The slotted aperture 86 can be formed when the wall member 40 is pierced or cut to form the locking tabs 48, or when the roller 32 is cast or molded.

With reference to FIGS. 6 through 8, the bearing 30 is received into the bearing socket 46 such that the outer bearing race 34 is non-rotatably coupled to the annular wall 56 of the bearing socket 46 and the outer bearing race 34 is disposed axially between the stop 58 and the distal ends 82 of each of the locking tabs 48. An outer circumferential surface 90 of the outer bearing race 34 can optionally be engaged to the annular bearing surface 60 in a press-fit manner. Additionally or alternatively, an adhesive material can be employed to fixedly couple the outer bearing race 34 to the annular bearing surface 60.

The locking tabs 48 are configured to limit axial movement of the outer bearing race 34 along the roller axis 68 in a direction away from the stop 58, while the stop 58 similarly limits axial movement of the outer bearing race 34 along the roller axis 68 in a direction away from the distal ends 82 of the locking tabs 48. Optionally, the distal ends 82 of the locking tabs 48 can abut an axial end of the outer bearing race 34 that is opposite the axial end of the outer bearing race 34 that abuts the stop 58. Alternatively, one or more spacing elements (not shown) can be disposed axially between the stop 58 and the outer bearing race 34 and/or between the distal ends 82 and the outer bearing race 34.

Returning to FIG. 2, a threaded fastener 100 can be received through the inner bearing race 36 and can be secured to the arm 14 to fixedly couple the inner bearing race 36 to the arm 14. It will be appreciated that the bearing 30 supports the roller 32 relative to the arm 14 for rotation about the roller axis 68, which is parallel to but offset from the pivot axis 20.

Returning to FIG. 6, a belt B is configured to contact the annular roller surface 50 in a contact zone Z. The annular roller surface 50 has an area that is greater than an area of the contact zone Z. The contact zone Z is centered along the roller axis 68 about the bearing elements 38 of the bearing 30.

With reference to FIGS. 6 and 8, a method for assembling a tensioner can include: providing a bearing 30 with an outer bearing race 34; inserting the bearing 30 into a bearing socket 46 in a roller 32 along a roller axis 68 such that distal ends 82 of a plurality of locking tabs 48 formed on the roller 32 are urged in a radially outward direction by an outer circumferential surface 90 of the outer bearing race 34; seating the bearing 30 in the bearing socket 46 such that the distal ends 82 of the locking tabs 48 release the outer circumferential surface 90 of the outer bearing race 34 and move radially inwardly to thereby limit movement of the outer bearing race 34 axially along the roller axis 68 in a direction toward the distal ends 82 of the locking tabs 48; securing the bearing 30 to an arm 14 such that an annular roller surface 50 of the roller 32 is rotatable about the roller axis 68 relative to the arm 14; and coupling the arm 14 to a base 12 for pivoting motion about a pivot axis 20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tensioner for tensioning a belt, the tensioner comprising:
a base;
an arm that is coupled to the base for movement relative to a movement axis; and
a roller assembly having a bearing and a roller, the bearing supporting the roller relative to the arm for rotation about a roller axis that is spaced apart from the movement axis, the bearing having an outer bearing race, an inner bearing race, and a plurality of bearing elements that are disposed radially between the outer and inner bearing races, the roller having a wall member that defines a roller member, a bearing socket and one or more locking tabs, the roller member having an annular roller surface that is disposed concentrically about the roller axis and configured to engage the belt, the bearing socket having an annular bearing surface, which is disposed concentrically within the annular roller surface, and a stop that is disposed radially inwardly from the annular bearing surface, each of the one or more locking tabs having a proximal end, which is resiliently coupled to an adjacent portion of the wall member, and a distal end that projects radially inward from the proximal end and the annular bearing surface;
wherein the bearing is received in the bearing socket such that the outer bearing race is disposed axially between the stop and the distal ends of each of the one or more locking tabs, and wherein the one or more locking tabs limit axial movement of the outer bearing race along the roller axis in a direction away from the stop.

2. The tensioner of claim 1, wherein the annular roller surface is a flat cylindrical surface.

3. The tensioner of claim 1, wherein the arm is pivotably coupled to the base for pivoting motion about the movement axis.

4. The tensioner of claim 1, wherein the stop comprises a segment of the wall member that extending radially inward from the annular bearing surface.

5. The tensioner of claim 1, wherein a slotted aperture is formed in the wall member about a perimeter of each of the one or more d.

6. The tensioner of claim 1, wherein the stop abuts an axial end of the outer bearing race.

7. The tensioner of claim 6, wherein the distal end of each of the one or more locking tabs abut an opposite axial end of the outer bearing race.

8. The tensioner of claim 1, wherein the distal end of each of the one or more locking tabs abut an axial end of the outer bearing race.

9. The tensioner of claim 1, wherein the outer bearing race is press-fit to the annular bearing surface.

10. The tensioner of claim 1, wherein a transition section of the wall member couples the bearing socket to the roller member, and wherein a portion of the transition section is frustoconically shaped.

11. The tensioner of claim 1, wherein the belt is configured to contact the annular roller surface in a contact zone, wherein the annular roller surface has an area that is greater than an area of the contact zone, and wherein the contact zone is centered along the roller axis about bearing elements of the bearing.

12. A method for assembling a tensioner comprising:
providing a bearing with an outer bearing race;
inserting the bearing into a bearing socket in a roller along a roller axis such that distal ends of a plurality of locking tabs formed on the roller are urged in a radially outward direction by an outer circumferential surface of the outer bearing race;
seating the bearing in the bearing socket such that the distal ends of the locking tabs release the outer circumferential surface of the outer bearing race and move radially inwardly to limit movement of the outer bearing race axially along the roller axis in a direction toward the distal ends of the locking tabs;
securing the bearing to an arm member such that an annular roller surface of the roller is rotatable about the roller axis relative to the arm member; and
coupling the arm member to a base for movement relative to a movement axis.

13. The method of claim 12, wherein the bearing is an angular contact bearing.

14. The method of claim 12, wherein the arm member is pivotally coupled to the base.
